(19) United States
(12) Patent Application Publication
(10) Pub. No.: US 2026/0186629 A1
(43) Pub. Date: Jul. 2, 2026

(54) SECURE AND INTERACTIVE USER INTERFACE FOR FEEDBACK ON A TERMINAL SYSTEM

(71) Applicant: Rahul Mutha, Norwood, MA (US)

(72) Inventor: Rahul Mutha, Norwood, MA (US)

(21) Appl. No.: 19/004,620

(22) Filed: Dec. 30, 2024

(51) Int. Cl. G06F 3/0484; G06F 21/60

(52) U.S. Cl. CPC G06F 3/0484; G06F 21/602

(57) ABSTRACT

The technical solutions provide secure and interactive user interface (UI) for secure feedback on a terminal system having an operation component with a first processor and first memory and a performance component with a second processor and a second memory. The operation component can complete an electronic operation and transmit, responsive to completion of the electronic operation, an operation identifier to the performance component. The performance component can cause, responsive to operation identifier, an arrangement of UI elements in a UI to initiate an input request. The performance component can identify, UI interaction with the UI element responsive to input request and construct a data structure corresponding to the UI interaction and including the operation identifier, and then transmit the data structure.

### TECHNICAL FIELD

This disclosure is directed to computing technology for processing terminal system operations, and particularly to enhancing user interaction and feedback mechanisms in terminal systems while improving data security and integrity.

### BACKGROUND

Terminal systems can be utilized for implementation of electronic operations, such as electronic secured transactions, for a variety of enterprises. It can be technically challenging to efficiently and reliably execute additional system processes on such terminal systems without compromising network security and data integrity.

### SUMMARY

Aspects of technical solutions disclosed herein are directed to secure and interactive user interface for feedback on a terminal system. For example, collecting and analyzing user engagement information pertaining to secured electronic operations utilizing confidential and sensitive data performed on behalf of users by terminal systems can be a challenge. Electronic operations, such as transactions implemented using electronic account confidential data, are performed by terminal systems in accordance with a high level of data integrity and security. The data exchanged in such operations is typically processed separately from other data to prevent feedback manipulation or unauthorized access to sensitive or confidential electronic user data. Consequently, it can be difficult to generate, collect and analyze feedback information from users utilizing such terminal system operations in order to identify user experience and performance improvement opportunities for entities using the terminal systems.

The technical solutions of this disclosure overcome these challenges by providing a user interface system for gathering terminal system feedback data via a performance component whose data processing is decoupled from the operation component processing electronic operations of the terminal device. This separation improves data security by isolating the processing of electronic operation data and user feedback data within the terminal system. The operation component and performance component each have their own dedicated processors and memory, allowing the operation component to complete electronic operations independently from the performance component's gathering of user interaction data on the terminal system. Moreover, in order to prevent feedback manipulations, the operation component can trigger the performance component feedback information gathering by transmitting an operation identifier upon the completion of the electronic operation. This allows the performance component to securely associate the user feedback information collected via requests for input through the terminal system's graphical user interface and corresponding user interactions with the operation identifier. The performance component can then maintain the integrity of the user feedback data by constructing a data structure based on the received user interactions associated with the operation identifier for secure transmission to a server and future processing, without compromising any confidential data involved in the operation processing.

An aspect of the technical solutions is directed to a system. The system can include a terminal system. The terminal system can include an operation component comprising a first one or more processors coupled with a first memory and a performance component comprising a second one or more processors coupled with a second memory. The operation component can be configured (e.g., via instructions or data stored in the first memory) to complete an electronic operation using information. The operation component can be configured to transmit, responsive to completion of the electronic operation, an operation identifier to the performance component. The performance component can be configured (e.g., via instructions or data stored in the second memory) to cause, responsive to receipt of the operation identifier, an arrangement of one or more graphical user interface elements in a graphical user interface of the terminal system to initiate one or more requests for input via the terminal system. The performance component can be configured to identify, one or more interactions with the one or more graphical user interface elements responsive to the one or more requests. The performance component can be configured to construct, based on the one or more interactions, a data structure corresponding to the one or more interactions with the graphical user interface and including the operation identifier. The performance component can be configured to transmit to a server via a network, the data structure.

The first one or more processors of the operation component can be configured to complete the electronic operation using the information corresponding to an electronic account for electronic transactions. The first one or more processors can be configured to clear, from the memory, the information in response to the completion of the electronic operation.

The first one or more processors of the operation component can be configured to generate the operation identifier to identify the electronic operation from a plurality of electronic operations associated with an entity of the terminal system. The second one or more processors of the performance component can be configured to generate the one or more requests according to a configuration of a survey of the entity. The second one or more processors of the performance component can be configured to identify the one or more graphical user elements for the one or more requests for input based on a second information associated with the electronic operation.

The second information can correspond to at least one of: a time of day of the electronic operation, a date of the electronic operation, a rate of electronic operations, one or more time durations of the one or more interactions or a portion of the operation identifier indicative of a configuration for the one or more graphical user interface elements to include in the arrangement. The second one or more processors can be configured to encrypt the data structure according to an encryption protocol prior to the transmission of the data structure for storage at the server. The second one or more processors can be configured to generate a request identifier to identify a request of the one or more requests for input and include the request identifier in the data structure prior to the transmission of the data structure to the server.

The second one or more processors can be configured to generate, for display via the graphical user interface, one or more predefined responses for the one or more requests for input. The second one or more processors can be configured to receive, via the graphical user interface responsive to the one or more requests for input, one or more inputs corresponding to the one or more predefined responses. The second one or more processors can be configured to identify, based on the one or more inputs, the one or more interactions. At least one of: the one or more predefined responses, the one or more inputs, the one or more requests or the one or more interactions can be stored in the second memory of the performance component prior to the transmission of the data structure. The second one or more processors can be configured to clear the second memory responsive to the transmission of the data structure.

The second one or more processors of the performance component can be configured to provide for display, via the graphical user interface, one or more emojis as the one or more graphical user interface elements corresponding with the one or more requests for input. The second one or more processors of the performance component can be configured to identify a time duration of the one or more interactions with one or more requests and include the time duration in the data structure, prior to the transmission of the data structure.

The second one or more processors of the performance component can be configured to identify one or more elements of the data structure corresponding to information indicative of the electronic operation, and encrypt the one or more elements in the data structure, prior to the transmission of the data structure to the server. The second one or more processors of the performance component can be configured to identify historical data of an electronic account associated with an entity of the terminal system, and adjust the one or more graphical user interface elements, based on the historical data.

The server can be configured to provide, responsive to a request comprising at least one of an identifier of the electronic operation or an identifier of an entity associated with the terminal system, the data structure. The second one or more processors of the performance component can be configured to include, in the data structure, a log of the one or more interactions with the graphical user interface elements. The log can identify the one or more interactions and one or more time durations of the one or more interactions.

An aspect of the technical solutions is directed to a method. The method can include a first one or more processors coupled with memory of an operation component of a terminal system, an electronic operation using information. The method can include transmitting, by the first one or more processors, responsive to completion of the electronic operation, an operation identifier to a performance component. The method can include a second one or more processors coupled with a second memory of the performance component of the terminal system causing, responsive to receipt of the operation identifier, an arrangement of one or more graphical user interface elements in a graphical user interface of the terminal system. The method can include initiating, by the second one or more processors based on the arrangement of the one or more graphical user interface elements, one or more requests for input via the terminal system. The method can include identifying, by the second one or more processors, one or more interactions with the one or more graphical user interface elements responsive to the one or more requests. The method can include constructing, by the second one or more processors, based on the one or more interactions, a data structure corresponding to the one or more interactions with the graphical user interface and including the operation identifier. The method can include transmitting, by the terminal system, the data structure to a server via a network.

The method can include the first one or more processors of the operation component completing the electronic operation using the information corresponding to an electronic account for electronic transactions. The method can include clearing, from the first memory of the operation component, the information in response to the completion of the electronic operation.

The method can include identifying, by the first one or more processors of the operation component, the electronic operation from a plurality of electronic operations associated with an entity of the terminal system. The method can include generating, by the second one or more processors, the one or more requests according to a configuration of a survey of the entity.

The method can include identifying, by the second one or more processors, the one or more graphical user elements for the one or more requests for input based on a second information associated with the electronic operation. The second information can correspond to at least one of: a time of day of the electronic operation, a date of the electronic operation, a rate of electronic operations, one or more time durations of the one or more interactions or a portion of the operation identifier indicative of a configuration for the one or more graphical user interface elements to include in the arrangement.

An aspect of the technical solutions is directed to a first non-transitory computer-readable medium storing processor-executable instructions. The instructions, when executed by a first one or more processors of an operation component of a terminal system, can cause the first one or more processors to complete an electronic operation using information and transmit, responsive to completion of the electronic operation, an operation identifier to a performance component. The technical solutions are further directed to a second non-transitory computer-readable medium storing processor-executable instructions, which when executed by a second one or more processors of the performance component of the terminal system, cause the second one or more processors to cause, responsive to receipt of the operation identifier, an arrangement of one or more graphical user interface elements in a graphical user interface of the terminal system to initiate one or more requests for input via the terminal system. The instructions, when executed by the second one or more processors of the performance component of the terminal system, can cause the second one or more processors to identify, one or more interactions with the one or more graphical user interface elements responsive to the one or more requests. The instructions, when executed by the second one or more processors of the performance component of the terminal system, can cause the second one or more processors to construct, based on the one or more interactions, a data structure corresponding to the one or more interactions with the graphical user interface and including the operation identifier. The instructions, when executed by the second one or more processors of the performance component of the terminal system, can cause the second one or more processors to transmit to a server via a network, the data structure.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 illustrates an example of a system for secure and interactive user interface for feedback on a terminal system.

FIG. 2 depicts a block diagram illustrating an architecture for a computer system that can be employed to implement elements of the systems and methods described and illustrated herein, including, for example, the system depicted in FIG. 1 and the operational flows or methods depicted in FIGS. 3 and 4.

FIG. 3 illustrates an example of a user interface (UI) with UI elements and input requests for a survey question on the quality of service.

FIG. 4 illustrates an example of a UI with UI elements and input requests for a survey question on rating of interaction with employees of the entity.

FIG. 5 illustrates an example of a UI with input requests and input features for a survey question on rating the user's happiness with the entity.

FIG. 6 illustrates an example of a feedback report plot from a survey report.

FIG. 7 illustrates an example of a flow diagram of a method for providing or configuring a survey system for an entity.

FIG. 8 illustrates an example of a flow diagram of a method for providing secure and interactive user interface for feedback on a terminal system.

### DETAILED DESCRIPTION

Following below are more detailed descriptions of various concepts related to, and implementations of, methods, apparatuses, and systems of secure and interactive user interface for feedback on a terminal system. The various concepts introduced above and discussed in greater detail below may be implemented in any of numerous ways.

Collecting and analyzing user engagement information for secured electronic operations performed on behalf of users by terminal systems can be challenging. These operations can include, for example, electronic transactions implemented on terminal systems utilizing confidential and sensitive client account data. In such instances, terminal systems can be configured to process and maintain electronic operation data, including any transaction or purchase data, at a high level of data integrity and security. This data can be typically processed separately from other data to prevent feedback manipulation or unauthorized access to sensitive or confidential user data. Consequently, it can be difficult to generate, collect, and analyze user feedback data for terminal system operations to identify user experience and performance improvement opportunities for entities utilizing the terminal systems for their enterprise operations.

The technical solutions of this disclosure overcome these challenges by providing a user interface system for gathering terminal system feedback data via a performance component whose data processing is decoupled from the operation component processing electronic operations of the terminal device. By separating the operation and performance data processing, using dedicated processors or memory for each of the components, the solutions can maintain security of operation and user feedback data within the terminal system. This can allow the operation component to complete electronic operations independently from the performance component's gathering of user interaction data on the terminal system improving data security. Upon completion of an electronic operation on behalf of a user, the operation component of the terminal device can transmit an operation identifier to the performance component, allowing the performance component to securely associate the user feedback information collected via requests for input through the terminal system's graphical user interface and corresponding user interactions with the operation identifier. The performance component can maintain the integrity of the user feedback data by constructing a data structure based on the received user interactions and associating it with the operation identifier for secure transmission to a server and future processing, without compromising any confidential data involved in the operation processing.

The technical solutions also improves data security and user interaction by incorporating predefined single-digit responses and touch screen-enabled input, simplifying data processing and minimizing input errors. The performance component can dynamically select survey questions based on the time of day and frequency of the electronic operations, ensuring varied feedback and preventing survey fatigue. The technical solutions can also utilize advanced encryption methods to protect survey data during transmission and storage and allow for secure back-end data processing of user survey data in connection with the operation identifiers without compromising the integrity of the operation data.

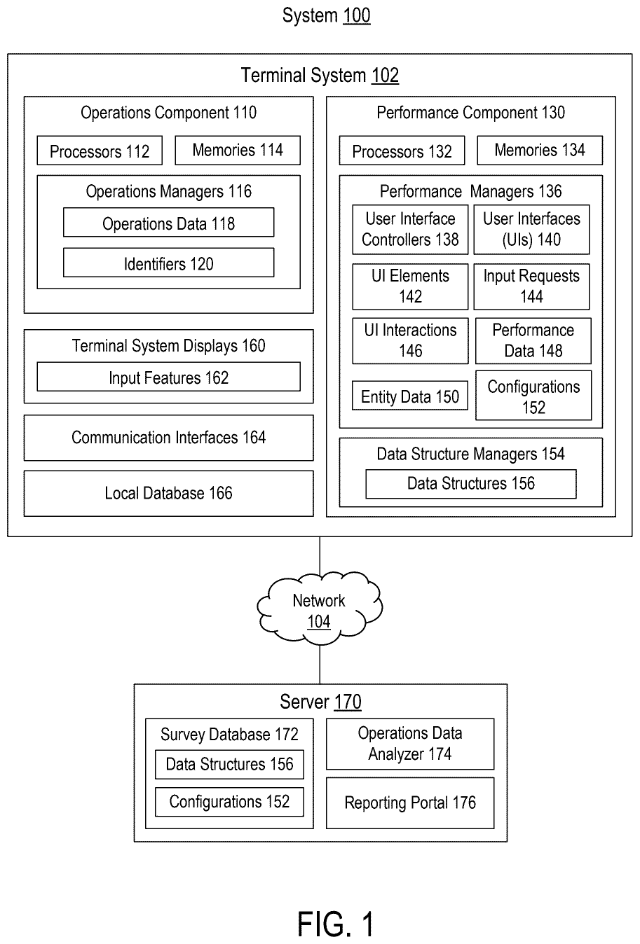

FIG. 1 depicts is an example of a system 100 for providing a secure and interactive user interface for feedback via a terminal system. The system 100 can include one or more terminal systems 102 communicatively coupled with one or more servers 170, via one or more networks 104. A terminal system 102 can include one or more of operations components 110, performance components 130, terminal system displays 160, communication interfaces 164 and local databases 166. An operations component 110 can include one or more processors 112 that are coupled with one or more memories 114 of the operations component 110 and configured to implement one or more operations managers 116. An operations manager 116 of the operations component 110 can be configured to complete electronic operations (e.g., electronic transactions) using operations data 118 and generate operation identifiers 120 associated with the completed operations for use by performance components 130. A performance component 130 can include one or more processors 132 coupled with one or more memories 134 of the performance component and configured to implement one or more performance managers 136. A performance manager 136 of the performance component 130 can include one or more user interface (UI) controllers for operating a UI 140, including arranging UI elements 142, initiating input requests 144 and receiving and recording user interactions 146. The UI elements 142, initiating input requests 144 and UI interactions 146 can be stored on a local database 166 along with various configurations 152 for configuring the surveys. The performance manager 136 can implement its actions using performance data 148, entity data 150 (e.g., data of the entity 702 deploying the terminal system 102) and configurations 152 for configuring the input requests 144 of the survey provided. The performance component can include one or more data structure managers 154 for generating data structures 156 based on the UI interactions 146 with the UI 140 and associating these data structures 156 with operation identifiers 120 before transmitting the data structure 156 to the server 170. The terminal system 102 can include one or more terminal system displays 160 with input features 162 for receiving UI interactions 146 for the performance manager 136, as well as one or more communication interfaces 164 for communicating with the server 170, via the network 104.

The server 170 can include one or more survey databases 172 for storing various data structures 156 from different terminal systems 102 of an entity (e.g., an enterprise, corporation or an organization) performing electronic operations (e.g., electronic transactions for various users) on behalf of the entity. The survey database 172 can store one or more configurations 152 for configuring individual surveys, such as generating arrangements of specific UI elements 142 to initiate input requests 144 (e.g., seeking user feedback on specific experiences associated with the implemented operations or transactions) and receive UI interactions 146 responsive to the input requests 144 generated according to the configuration 152. The server 170 can include one or more operations data analyzers 174 and reporting portals 176 for analyzing data structures 156 to identify actions for improving performance goals for the entity and providing reports or plot analyses of the survey data.

For example, a system 100 of an operation environment by an entity 702 providing terminal systems 104 for servicing users can include a terminal system 102 having an operations component 110 and a performance component 130. The operations component 110 can utilize its own one or more processors 112 and one or more memories 114 to utilize operations data 118 (e.g., user confidential or sensitive data, such as credit card or account information) to complete electronic operations (e.g., credit card transactions). The operations component 110 can generate an operation identifier 120 uniquely identifying the electronic operation on the system 100. Upon completion of the electronic operation, the operations component 110 can clear the memory 114 to remove any operations data 118 and provide, share or transmit the operation identifier 120 to the performance component 130. The performance component 130 can operate its performance manager 136 and data structure manager 154 using its own one or more processors 132 and memories 134. The performance management 136 can utilize a configuration 152 to generate an arrangement of graphical UI interface elements 142 (e.g., requests for user feedback on particular issues associated with the electronic operation) to initiate one or more input requests 144 to be displayed via a terminal system display 160. The performance manager 136 can receive, via input features 162 on the terminal system display 160 and responsive to the input requests 144, one or more graphical UI interactions 146 indicative of the user feedback on the issues associated with the electronic operation. The performance manager can utilize the data structure manager 154 to generate a data structure 156 based on, or including, the UI interactions 146, performance data 148 (e.g., logs on user interactions and time durations associated with the user survey session) or entity data 150 (e.g., historical data associated with electronic account of the entity 702 deploying the terminal system). The data structure manager 154 can include or associate with the data structure 156, an operation identifier 120 to transmit the data structure 156 to the entity server 170, which can utilize its operations data analyzer 174 to analyze and improve the user experience and safely and securely track the electronic operation (e.g., via the operations identifier 120).

As is shown in FIG. 1, the operations component 110 and the performance component 130 do not share any operational components with each other, including any processors for processing data or memories for temporary or permanent data storage. For example, the operations component 110 can implement or execute all of its operations using one or more processors 112 and one or more memories 114, none of which are accessible or used by the performance component 130. Meanwhile, the performance component 130 can implement or execute all of its operations using one or more processors 132 and one or more memories 134, none of which are accessible or used by the operations component 110. This physical separation of the storage and processing hardware can improve the data integrity and the security of the overall system 100.

Terminal system 102 can include any combination of hardware and software for performing electronic operations and collecting user feedback. Terminal system 102 can be communicatively coupled with one or more servers 170 via one or more networks 104. Terminal system 102 can include operations component 110, performance component 130, terminal system display 160, and communication interface 164. For example, terminal system 102 can be used in a trading environment, such as retail environment, to process electronic operations. Terminal system 102 can include a terminal device, such as a terminal device with a keypad and a slot for a credit card swipe or near infra-red (NIR) touch transaction feature. The electronic operations can include any data operations utilizing confidential or sensitive data, such as electronic credit card or debit card transactions, online purchases, bank account fund transfers, bill payments, point of sale (POS) transactions, cryptocurrency transactions or any other electronic operations using secured data. The terminal system 102 can be used and gather customer feedback on the electronic operations on the service or electronic operation provided. Terminal system 102 can check that the feedback collection process is secure and does not interfere with the electronic operations being performed. Terminal system 102 can transmit collected feedback data to server 170 for further analysis and storage.

Operations component 110 can include any combination of hardware and software for completing electronic operations. Electronic operations can include any activities or processes performed by electronic systems to complete tasks, such as transactions, data transfers, or communications associated with confidential user data. Electronic operations can include credit card transactions, online purchases, bank transfers, mobile payments, bill payments, point of sale transactions, subscription services, peer-to-peer payments, or cryptocurrency transactions, which can utilize confidential information of the user (e.g., credit card or bank accounts) to be maintained securely.

Operations component 110 can include one or more processors 112 coupled with one or more memories 114 and configured to implement operations manager 116. Operations component 110 can complete electronic operations using operations data 118 and generate operation identifiers 120 associated with the completed operations. For example, operations component 110 can process electronic operations and generate unique identifiers 120 for each such operation. Operations component 110 can check or verify that sensitive data associated with the electronic operation is processed securely and cleared from memory 114 of the operations components 110 after the operation is completed. The operations component 110 can transmit operation identifiers 120 to performance component 130 for further processing or inclusion into the data structure 156.

Processor 112 can include any type of processing unit for executing instructions and performing computations associated with electronic operations of the operations component 110. Processor 112 can be coupled with memory 114 and configured to implement operations manager 116 and its functionalities. For instance, the processor 112 can complete electronic operations using operations data 118 and generate operation identifiers 120. For example, processor 112 can execute instructions to process a credit card transaction and generate a unique identifier for the transaction. Processor 112 can ensure that the electronic operation is completed efficiently and securely. Processor 112 can transmit operation identifiers 120 to performance component 130 for further processing.

Memory 114 can include any type of storage medium capable of storing data and instructions for the operations component 110. Memory 114 can be coupled with processor 112 and configured to store operations data 118 and instructions for operations manager 116 and implementation of its functionalities. Memory 114 can store data related to electronic operations and clear the confidential operations data 118 after the operation is completed. For example, memory 114 can store credit card information during a transaction and clear the information after the transaction is completed. Memory 114 can ensure that sensitive data is stored securely and cleared promptly to maintain data integrity. The memory 114 can store operation identifiers 120 generated by processor 112 and share it with the performance component 130.

Operations manager 116 can include any combination of hardware and software for managing and completing electronic operations. Operations manager 116 can be implemented by processor 112 based on instructions, data or computer code stored in memories 114. The operations manager 116 can be configured to use confidential or secured operations data 118 to complete electronic operations. Operations manager 116 can generate operation identifiers 120 associated with the completed operations. For example, operations manager 116 can process a user account or a credit card transaction and generate a unique operation identifier 120 associated with this electronic operation. The operations manager 116 can ensure that the electronic operation is completed securely and efficiently and can transmit operation identifier 120 of the electronic operation to the performance component 130.

Operations data 118 can include any type of data related to, or used for, electronic operations. Operations data 118 can be stored in memory 114 and used by operations manager 116 to complete electronic operations. Operations data 118 can include sensitive information such as credit card numbers, account numbers, user debit card or account passwords or passcodes, username and password information, or any other user related or account data. Operations data 118 can include information on articles or goods transacted via an electronic operation, such as products or services purchased via the electronic operation. For example, operations data 118 can include the credit card information used to process a transaction. Operations data 118 can be cleared from memory 114 after the operation is completed to maintain data security.

Identifier 120 can include any type and form of an identifies associated with, or identifying uniquely, an electronic operation. Identifier 120 can be generated by operations manager 116 and used by performance component 130 to associate user feedback with the corresponding operation. Identifier 120 can ensure that feedback data is linked to the correct operation without compromising sensitive information. For example, identifier 120 can be a unique transaction ID generated during a purchase or a credit card transaction. Identifier 120 can be transmitted to performance component 130 for further processing and included in data structures 156.

In addition to operation identifier 120, the terminal system 102 can include an identifier of the terminal system or the terminal device, such as an identifier of a pin entry device (PID). The PID identifier can be incorporated into the data structure 156 and be used to associate the terminal with the transaction and the survey feedback data. The entity (e.g., the enterprise providing or utilizing terminal systems 102) can include store identifiers for identifying a store within which the terminal device (e.g., PID) is located. The system 100 can include a register identifier to identify a register from which the survey response was entered. The system 100 can include a question identifier to identify the question of the survey provided on the UI 140.

Performance component 130 can include any combination of hardware and software for collecting and processing user feedback. The performance component 130 can collect the user feedback via data gathering of UI interactions 146 and performance data 148 and provide the user feedback information, via a data structure 156 transmitted over the network 104, to the server 170. Performance component 130 can include one or more processors 132 coupled with one or more memories 134 and configured to implement the performance manager 136 and its functionalities. Performance component 130 can generate input requests 144 via UI 140 and receive UI interactions 146 from users. For example, performance component 130 can display an arrangement of UI elements 142 representing a survey on a terminal system display 160 and collect UI interactions 146 received via input features 162 of the terminal system display 160. Performance component 130 can construct data structures 156 based on the received interactions and associate the data structures 156 with operation identifiers 120. The performance component 130 can transmit data structures 156 to server 170 for further analysis.

Processor 132 can include any type of a processing unit capable of executing instructions and performing computations for a performance component 130. Processor 132 can be coupled with memory 134 of the performance component 130 and can be configured (e.g., via instructions or data in the memory 134) to implement performance manager 136 and its functionalities. Processor 132 can generate input requests 144 and receive UI interactions 146 from users. For example, processor 132 can execute instructions to display a survey on terminal system display 160 and collect user responses (e.g., UI interactions 146). Processor 132 can check that user feedback is collected efficiently and securely and construct data structures 156 based on the received interactions for their transmission to the server 170.

Memory 134 can include any type of storage medium capable of storing data and instructions for the performance component 130. Memory 134 can be coupled with processor 132 and configured to store performance data 148, entity data 150, and configurations 152. Memory 134 can store data related to user feedback (e.g., UI interactions 146 and operations identifiers 120) and clear such data after the data is processed. For example, memory 134 can store user responses to a survey and clear the information after it is transmitted to server 170. Memory 134 can ensure that feedback data is stored securely and cleared promptly to maintain data integrity.

Performance manager 136 can include any combination of hardware and software for managing and processing user feedback. For instance, the performance manager 136 can include the functionalities for generating surveys (e.g., arrangements of UI elements 142 to initiate input requests 144 according to configurations 152 of the entity (e.g., corporation or organization utilizing system 100). The performance manager 136 can be implemented by processor 132 and configured to use performance data 148, entity data 150, and configurations 152 to generate input requests 144 and receive UI interactions 146. The performance manager 136 can construct data structures 156 based on the received interactions and associate them with operation identifiers 120. For example, performance manager 136 can display a survey on terminal system display 160 and collect user responses. The performance manager 136 can ensure that user feedback is collected securely and efficiently and can transmit data structures 156 to server 170 for further analysis of the data by the server.

UI controller 138 can include any combination of hardware and software for providing or operating a user interface (UI) 140. UI controller 138 can be implemented by performance manager 136 and configured to arrange UI elements 142, initiate input requests 144, and receive UI interactions 146. UI controller 138 can operate the user interface such that the user interface 140 is interactive and user-friendly. The UI controller 138 can provide prompts on the UI 140 prompting the user for response to questions pertaining to the electronic operation completed by the operations component 110. For example, UI controller 138 can display an arrangement of UI elements 142 forming or representing questions of a survey on terminal system display 160 to prompt user responses via UI interactions 146 on the input features 162 of the terminal system display 160. The UI controller 138 can ensure that the feedback collection is seamless and does not interfere or interact with the electronic operations being performed. For instance, the UI controller 138 can initiate the feedback information process upon completion of the electronic operation. The UI controller 138 can transmit the collected interactions to performance manager 136 for further processing.

UI component 138 can implement one or more survey rules to be applied with respect to electronic operation details. The survey rules of the UI component 138 can include rules for configuring or constructing the selection of questions or prompts for the UI 140 to maintain the relevance to the electronic operation and its data. The survey rules can include, for example, functionality or code for dynamically selecting survey questions based on the time of day and frequency of transactions, ensuring varied feedback and preventing survey fatigue. The survey rules can include or provide for predefined single-digit responses and touch screen-enabled input to simplify data processing and minimize input errors. The survey rules can incorporate advanced encryption methods, such as AES and RSA, to protect survey data during transmission and storage. The rules can allow the feedback collection process to remain secure, efficient, and provide valuable insights into customer engagement and satisfaction without compromising the integrity of the electronic operation data.

UI 140 can include any combination of hardware and software for providing a graphical user interface on terminal system display 160. The UI 140 can be operated by a UI controller 138 and configured to display UI elements 142 and initiate input requests 144. The UI can be a graphical user interface (GUI) displaying graphical UI elements 142, such as graphical icons or images to prompt user inputs or selections. For instance, a GUI 140 can provide a combination of one or more textual outputs (e.g., strings of text displayed on a display) indicating questions or prompts for the user to respond to, as well as one or more GUI elements 142 that include shapes, objects or images for user selection in response to the provided questions or prompts. The UI 140 can display UI elements in an arrangement according to configuration 152 for a survey. For example, UI 140 can display a survey on terminal system display 160 and collect user responses via UI interactions 146. The UI 140 can be displayed on a terminal system display 160 to allow or prompt the user provide the user feedback via input features 162.

UI elements 142 can include any textual or graphical components or representations displayed on UI 140 for interacting with users. UI elements 142 can include questions or prompts for a response or graphical icons for user selection. UI elements 142 be arranged by UI controller 138 and configured to initiate input requests 144. For instance, UI elements 142 can include a question about an electronic operation and a series of response choices associated with graphical elements, prompting the user to select a choice (e.g., interact with a UI element 142) to indicate the user feedback as it relates to the question or prompt. The UI elements 142 can include buttons, text fields, checkboxes, and other interactive components. For example, UI elements 142 can include buttons for users to rate their experience or text fields for providing feedback. The UI elements 142 can ensure that the feedback collection process is interactive and user-friendly.

Input requests 144 can include any prompts or questions displayed on UI 140 for collecting user feedback. Input requests 144 can be initiated by UI controller 138 and configured to receive UI interactions 146. The input requests 144 can include predefined questions, rating scales, and open-ended prompts. For example, input requests 144 can include questions about the user's experience with the service provided. The input requests 144 can be generated according to the configuration 152 of the entity and can address specific nature or characteristics of the electronic operation, including the goods or services transacted, waiting time experienced by the user, customer service feedback of the user or any other information pertaining to entity operations. The input requests 144 can initiate the interactions to be provided to the performance manager 136 for further processing.

UI interactions 146 can include any user responses or actions detected via the UI 140 or input features 162, in response to input requests 144 or UI elements 142. The UI interactions 146 can be received by UI controller 138 and recorded by the performance manager 136. The UI interactions 146 can include any type of user selection or action, such as button clicks, text inputs, option selections, button pressed signals or any other signals indicative of a user action or response. For example, UI interactions 146 can include selection indications pertaining to users rating their experience or providing feedback in text fields, including for example user waiting time, quality of customer service the user experienced, product selection satisfaction or other information. The UI interactions 146 can be used to construct data structures 156 for further analysis.

Performance data 148 can include any data related to the performance of the terminal system 102 and user interactions. Performance data 148 can be stored in memory 134 and used by performance manager 136 to generate input requests 144 and process UI interactions 146. The performance data 148 can include logs of user interactions, such as time durations of the user survey, number of user surveys associated with client accounts or the entity, information on users who performed the survey and those who did not. For example, performance data 148 can include the time taken by users to complete a survey or a percentage of users who performed the survey versus those who did not. Performance data 148 can include user feedback information pertaining to certain prompts or input requests 144, such as responses of the user corresponding to a user satisfaction with a user experience, or user's preference for goods and services provided. The performance data can be used to verify the efficiency of the feedback collection process and provide insights into the process. The performance data 148 can be used (e.g., by the operations data analyzer 174) to improve the user experience and performance of terminal system 102.

Entity data 150 can include any data related to the entity, such as a corporation, enterprise, organization or a store, deploying terminal system 102 onto its system 100. Entity data 150 can be stored in memory 134 and used by performance manager 136 to generate input requests 144 and process UI interactions 146. Entity data 150 can include historical data, configuration settings 152, and other relevant information pertaining to the entity. For example, entity data 150 can include historical feedback data from previous surveys, number of electronic operations performed or time distribution of the entity operations per day, week, month or year. Entity data 150 can check that the feedback collection process is tailored to the specific preferences of the entity and can be used to improve the user experience and performance of the terminal system 102 or entity operations.

Configurations 152 can include any settings or parameters used to setup or configure the input requests 144 and UI elements 142 to receive a particular user feedback. Configurations 152 can be generated or provided by an entity, such as a server 170 that can be used by the entity operators to select questions or prompts for different surveys. A configuration 152 can be a configuration of a survey having a selection of questions or prompts to provide to the user. The configurations 152 can be changed based on the time of day, day of the week, week of the month or the time of the year. The configuration 152 can be stored in memory 134 and used by performance manager 136 to generate input requests 144 and arrange UI elements 142. Configurations 152 can include predefined questions, rating scales, and other survey settings. For example, configurations 152 can include a set of questions to be displayed in a survey. The configurations 152 can ensure that the feedback collection process is comprehensive and relevant. The configurations 152 can be used to tailor the survey to the specific needs of the entity deploying terminal system 102.

Data structure manager 154 can include any combination of hardware and software for generating and managing data structures 156. The data structure manager 154 can be implemented by performance manager 136 and can be configured to construct data structures 156 based on the user requests or prompts (e.g., input requests 144 or UI elements 142) and the received user feedback (e.g., UI interactions 146). The data structure manager 154 can have operation identifiers 120 identifying or associating data structures 156, such that when transmitted to the server 170 can identify the data structure 156 for a particular electronic operation. For example, data structure manager 154 can generate a data structure containing user feedback and the corresponding operation identifier. Data structure manager 154 can ensure that the feedback data is securely transmitted and stored, including any UI interactions 146, performance data 148 or entity data 150. The data structure manager 154 can be used by the operations data analyzer 174 to analyze the user experience in view of the electronic operation (e.g., transaction) and any goods and services transacted, which that the operations data analyzer 174 can identify or access, based on operation identifier 120.

Data structure 156 can include any organized collection of data related to user feedback (e.g., UI interactions 146, performance data 148 or entity data 150) associated with a specific electronic operation. Data structure 156 can be any formatted or structured collection of data, such as user feedback data, which is generated by data structure manager 154 and associated with an operation identifier 120 uniquely identifying the operation to which the feedback data pertains. Data structure 156 can include any combination of UI interactions 146, performance data 148, and entity data 150 along with any UI elements 142 and input requests 144 requesting the feedback data. For example, data structure 156 can include user feedback collected from a survey and the corresponding operation identifier. Data structure 156 can ensure that the feedback data is securely transmitted and stored. The data structure 156 can be transmitted to server 170 for storage at the server 170 and further analysis by the operations data analyzer 174.

Terminal system display 160 can include any combination of hardware and software for displaying UI 140 and receiving UI interactions 146. Terminal system display 160 can be coupled with performance component 130 and configured to display input requests 144 and UI elements 142. Terminal system display 160 can provide a graphical user interface with graphical outputs and input features 162 presented as graphical icons for user input, such as touch screen icons. For example, the terminal system display 160 can display a survey and collect user responses. The terminal system display 160 can ensure that the feedback collection process is seamless and does not interfere with the electronic operations being performed. The terminal system display 160 can transmit the collected interactions to performance manager 136 for further processing.

Input features 162 can include any hardware or software components for receiving user inputs on terminal system display 160. Input features 162 can be coupled with performance component 130 and configured to receive UI interactions 146. Input features 162 can include touchscreens or touchscreen components, buttons, and other input devices. For example, input features 162 can include a touchscreen with active areas for receiving user inputs and user interaction with the survey question displayed on terminal system display 160. Input features 162 can ensure that the feedback collection process is interactive and user-friendly. The input features 162 can transmit the collected interactions to performance manager 136 for further processing.

Communication interface 164 can include any combination of hardware and software for enabling communication between terminal system 102 and server 170. Communication interface 164 can be coupled with performance component 130 and configured to transmit data structures 156 to server 170, via a network 104. Communication interface 164 can include an interface for operators of the entity (e.g., 702) to configure or set up various questions and schedules of a configuration 152 for deploying surveys using terminal systems 102 of the entity. The communication interface 164 can include any components or devices for data transmissions via the network 104, including electronic operations data transmitted to point of sale devices or servers for completion or verification of the electronic transactions. The communication interface 164 can ensure that the feedback data is securely transmitted over network 104. For example, communication interface 164 can use encryption protocols to protect the data during transmission.

Local database 166 can include any type of storage medium for storing configurations 152 and survey information on terminal system 102. Local database 166 can store various data elements such as UI elements 142, input requests 144, user interactions 146, performance data 148, entity data 150, and configurations 152. For example, local database 166 can store the predefined questions and answer formats for surveys to be presented to users. Local database 166 can be accessed or used by entity operators to update configurations 152, ensuring that the survey questions and formats are relevant and up-to-date. This can allow the entity to tailor the survey experience to their specific needs and gather meaningful feedback from users. The local database 166 can ensure that survey information is stored securely and can be retrieved efficiently by performance component 130 for processing and analysis.

Network 104 can include any combination of hardware and software for enabling communication between terminal system 102 and server 170. Network 104 can include connections or mediums for implementing transmission of data structures 156, operation identifiers 120, and other relevant information between terminal system 102 and server 170. For example, network 104 can include wired or wireless communication technologies such as the Internet, including Ethernet, Wi-Fi, or cellular networks. Network 104 can support real-time communication, allowing terminal system 102 to send and receive data.

Server 170 can include any combination of hardware and software for storing and analyzing feedback data from terminal system 102. Server 170 can be communicatively coupled with terminal system 102 via network 104 and configured to store data structures 156 in a survey database 172. For example, server 170 can access data structures 156 associated with various electronic operations via operation identifiers 120. The server 170 can analyze the feedback data from the data structures 156 to identify areas for improvement in the user experience, including with respect to operations data 118 (e.g., lists of goods or services purchased during a transaction). Server 170 can ensure that the feedback data is used to enhance the performance of terminal system 102. The server 170 can provide configuration 152 updates to terminal system 102.

Survey database 172 can include any type of storage medium for storing data structures 156 from terminal system 102. Survey database 172 can be coupled with server 170 and configured to store feedback data securely. Survey database 172 can ensure that the feedback data is organized and easily accessible for analysis by the operations data analyzer 174. The survey database 172 can store user feedback collected from surveys and the corresponding operation identifiers. The database 172 can store operations data 118, including any data corresponding to an electronic operation (e.g., electronic transaction) performed on the terminal system 102. The survey database 172 can ensure that the feedback data is used to improve the user experience and performance of terminal system 102 and store historical feedback and other data for trend analysis.

Operations data analyzer 174 can include any combination of hardware and software for analyzing data structures 156 to identify actions for improving performance goals for the entity. Operations data analyzer 174 can be implemented by the server 170 and configured to analyze feedback data (e.g., data structures 156) identified according to their operation identifiers 120. Using operation identifiers 120 the operations data analyzer 174 can access securely the operations data 118 (e.g., transactions data for the electronic operation) using the operation identifier 120 extracted from the data structure 156. The operations data analyzer 174 can analyze the user feedback (e.g., UI interactions 146, performance data 148 and entity data 150 representing user selections or responses to various input requests 144) in view of the operations data 118 to determine or identify opportunities or actions for improvement of user satisfaction. The operations data analyzer 174 can ensure that the feedback data is used to enhance the performance of terminal system 102. For example, operations data analyzer 174 can identify trends in user feedback and suggest improvements to the user interface. Operations data analyzer 174 can ensure that the feedback data is used to provide valuable insights into customer engagement and satisfaction. The operations data analyzer 174 can generate reports based on the analyzed data for further decision-making.

Reporting portal 176 can include any combination of hardware and software for managing the secure collection and processing of survey data. A reporting portal 176 can include the functionality designed to manage the secure collection and processing of survey data separately from sensitive transaction data. The reporting portal 176 can be a part of the server 170 for ensuring that the survey data is handled separately from sensitive transaction data, maintaining data integrity and security. For example, the reporting portal 176 can operate with the communication interface 164 of the terminal system 102 to securely communicate operation data 118 and survey responses without compromising personal card industry (PCI) information or personally identifiable information (PII). The reporting portal 176 can implement encryption protocols to protect survey data during transmission and storage, allowing to maintain user feedback secure. The reporting portal 176 can include the functionality for allowing or providing user access to review and analyze the survey data and provide or generate reports or plots based on the surveys (e.g., input requests 144, UI interactions 146 and performance data 150) associated with, or in connection with, any electronic operations performed by the operations component 110.

The UI elements 142, input requests 144 and UI interactions can be implemented using any combination of text or graphics. The text-based feedback can allow customers to provide detailed and specific feedback by typing text responses. The terminal system 102 can display a series of text-based questions on the terminal system display 160, and customers can use the device's keypad or input features 162 to enter their responses. Each response can be captured in real-time by the performance component 130 and stored securely in memory 134. For example, a customer can type their opinion about the service they received, and the feedback can be stored as part of the data structure 156. This feature can capture nuanced opinions and suggestions, providing valuable insights into customer experiences.

The graphics based feedback can include, for example, emojis or other images. For instance, the technical solutions can include emoji-based feedback can enable customers to respond to survey questions using emojis. The terminal system 102 can present questions along with a selection of emojis representing different sentiments (e.g., happy, neutral, sad) on the terminal system display 160. Customers can select the emoji that best represents their response by touching the screen or using the keypad. The performance component 130 can record these interactions as UI interactions 146 and store them securely. For example, a customer can select a happy emoji to indicate satisfaction with the service. This feature can provide a quick and easy way for customers to give feedback, offering a clear and immediate understanding of customer sentiment and engaging customers with a more interactive and visually appealing interface.

The technical solutions can utilize timing information to draw inferences and determinations about user sentiment or feedback. For instance, time-based feedback can track the time taken by customers to complete each survey question. The terminal system 102 can record the start and end time for each question using the performance component 130. This data can be analyzed to understand customer engagement and identify any questions that may be confusing or too complex. For example, if a customer takes a long time to answer a particular question, it may indicate that the question needs to be simplified. This feature can provide insights into customer engagement levels, help identify and improve questions that may take longer to answer and allow for optimization of survey length and question complexity.

The technical solutions can rotate the questions to prevent survey fatigue. For instance, rotating question feedback can ensure varied feedback and prevent survey fatigue by rotating a set of questions provided to users (e.g., customers). The terminal system 102 can have a pool of questions, and each customer can be presented with a randomized subset of these questions on the terminal system display 160. The selection algorithm can ensure that over time, all questions are evenly distributed among respondents. For example, one customer may be asked about their overall satisfaction, while another may be asked about the cleanliness of the store. This feature can prevent survey fatigue by varying the questions, ensure comprehensive feedback on different aspects of the service or product, and keep the survey experience fresh and engaging for repeat customers.

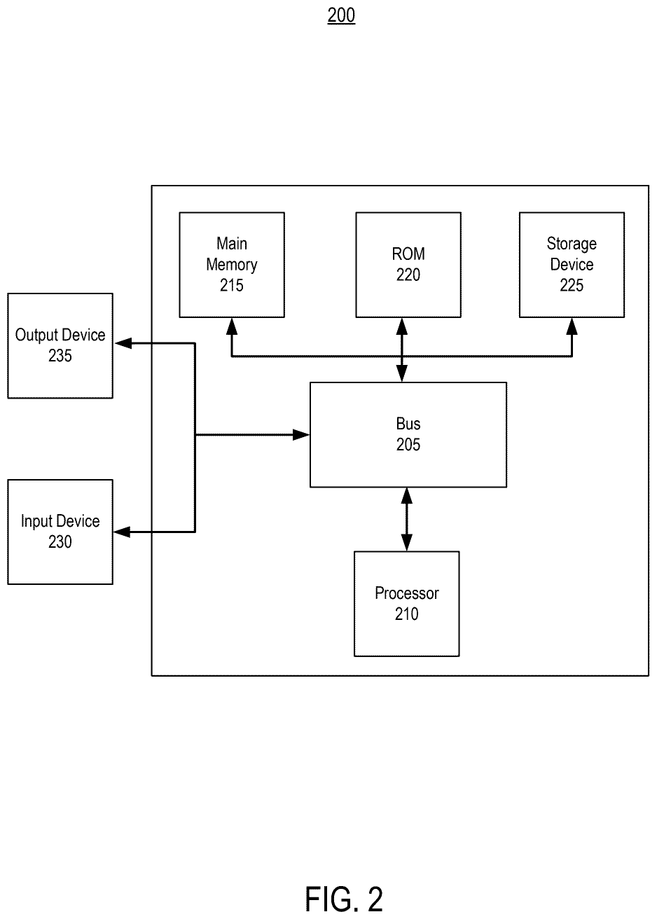

FIG. 2 is a block diagram of an example computer system 200. The computer system or computing device 200 can include or be used to implement the system 100, or its components such as the terminal system 102 (e.g., its operations components 110 or performance components 130), as well as the server 170. The computing system 200 can include a bus 205 or other communication component for communicating information and a processor 210 or processing circuit coupled to the bus 205 for processing information. The bus 205 can interconnect the components of the system 100, such as the terminal system 102 or server 170.

The computing system 200 can also include one or more processors 210 or processing circuits coupled to the bus 205 for processing information. The computing system 200 also includes main memory 215, such as a random access memory (RAM), static RAM, dynamic RAM, flash memory, cache memory or other static or dynamic storage device, coupled to the bus 205 for storing information, and instructions to be executed by the processor 210.

The main memory 215 can be or include the data repository for storing any data or values described herein. The main memory 215, as well as the main memory 215, can also be used for storing position information, temporary variables, data or other intermediate information during execution of instructions by the processor 210. The computing system 200 can further include a read only memory (ROM) 220 or other static storage device coupled to the bus 205 for storing static information and instructions for the processor 210. A storage device 225, such as a solid state device, magnetic disk or optical disk, can be coupled to the bus 205 to persistently store information and instructions. The storage device 225 can include or be part of the data repository.

The computing system 200 can be coupled via the bus 205 to an output 235, such as a liquid crystal display, or active matrix display, for displaying information to a user. An input device 230, such as a keyboard including alphanumeric and other keys, can be coupled to the bus 205 for communicating information and command selections to the processor 210. The input device 230 can include an output device 235, such as a touch screen display. The input device 230 can also include a cursor control, such as a mouse, a trackball, or cursor direction keys, for communicating direction information and command selections to the processor 210 and for controlling cursor movement on the output device 235, e.g., the display. The output 235 can be part of the terminal system 102 or any other components of FIG. 1.

The processes, systems and methods described herein can be implemented by the computing system 200 in response to the processor 210 executing an arrangement of instructions contained in main memory 215. Such instructions can be read into main memory 215 from another computer-readable medium, such as the storage device 225. Execution of the arrangement of instructions contained in main memory 215 causes the computing system 200 to perform the illustrative processes described herein. One or more processors in a multi-processing arrangement can also be employed to execute the instructions contained in main memory 215. Hard-wired circuitry can be used in place of or in combination with software instructions together with the systems and methods described herein. Systems and methods described herein are not limited to any specific combination of hardware circuitry and software.

Although an example computing system has been described in FIG. 2, the subject matter including the operations described in this specification can be implemented in other types of digital electronic circuitry, or in computer software, firmware, or hardware, including the structures disclosed in this specification and their structural equivalents, or in combinations of one or more of them.

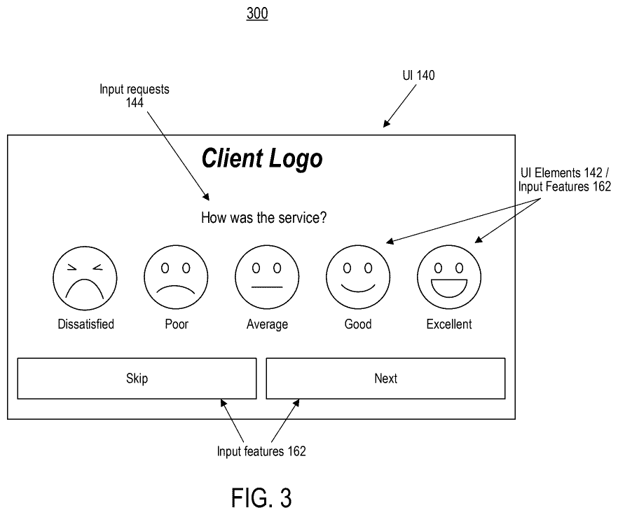

FIG. 3 illustrates an example 300 of a UI 140 with UI elements 142 and input requests 144 for a survey question on the quality of service. Following the completion of an electronic operation, the UI 140 can provide one or more prompts. The UI 140 can provide a window to display on a terminal system display 160 a text asking the user “How was the service?” and prompting the user to provide a response. The UI 140 can include one or more input features 162, stating “Skip” and “Next” allowing the user to select one of these two choices if the user does not want to answer. The UI elements 142 can also include input features 162 providing facial expression images, such as emojis, prompting the user to select between five choices representing five levels of service corresponding to different facial expression, including: “dissatisfied”, “poor”, “average”, “good” and “excellent” selections, which the user can choose from to provide the feedback response.

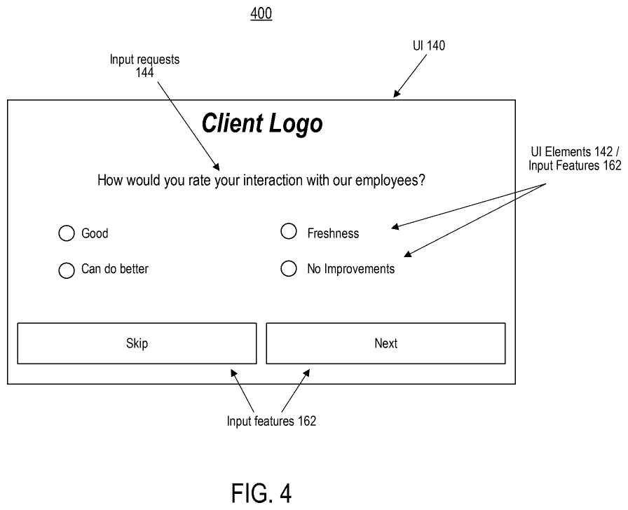

FIG. 4 illustrates an example 400 of a UI 140 with UI elements 142 and input requests 144 for a survey question on rating of interaction with employees. Following the completion of an electronic operation, the UI 140 can provide the prompt window asking the user “How would you rate your interaction with our employees?” and prompting the user to provide a response. The UI 140 can include one or more input features 162, stating “Skip” and “Next” allowing the user to select one of these two choices if the user does not want to answer. The UI elements 142 can also include input features 162 providing buttons for user selection corresponding to: “good”, “can do better”, “freshness” and “no improvements”, which the user can select from to provide the feedback response.

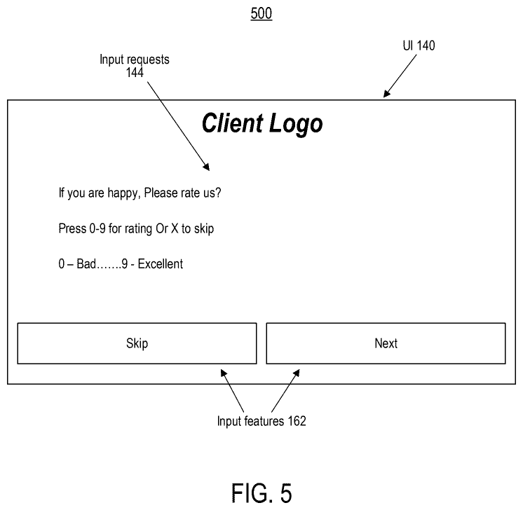

FIG. 5 illustrates an example 500 of a UI 140 with input requests 144 and input features 162 for a survey question on rating the user's happiness with the entity. The UI 140 can provide the prompt window asking the user “If you are happy, please rate us? Press 0-9 for rating or X to skip. 0—Bad and 9—Excellent” thereby prompting the user to provide a response. The UI 140 can include one or more input features 162, stating “Skip” and “Next” allowing the user to select one of these two choices if the user does not want to answer. The input features 162 in this instance can be the terminal device input pad numbers (e.g., 0-9).

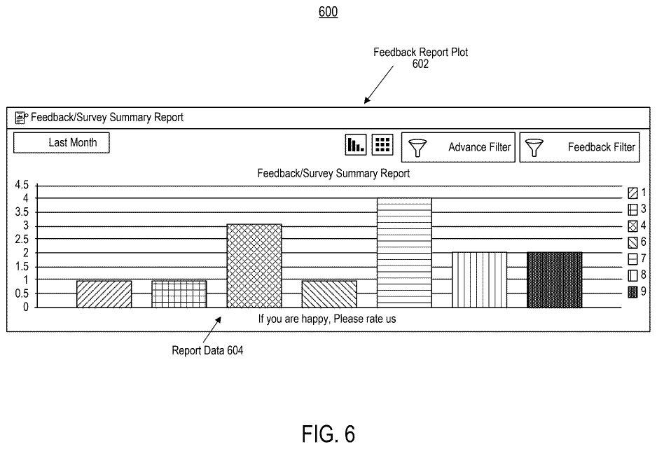

FIG. 6 illustrates an example 600 of a feedback report plot 602 from a survey report. The feedback report plot can include a plot of the report data 604 from a survey question presented in example 500 of FIG. 5. The feedback report plot 602 can plot the survey responses from the users rating the users'happiness with the entity from 0-9, providing a histogram of the response data. The feedback report plot 602 can be output from the operations data analyzer 174 analyzing the data structures 156 from any number of survey questions provided to various users of the system.

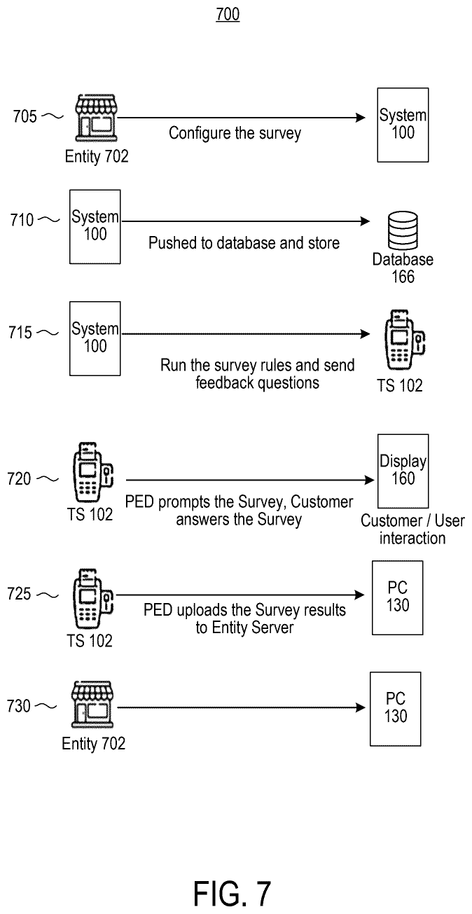

FIG. 7 illustrates an example of a flow diagram of a method 700 for providing or configuring a survey system for an entity. The method 700 can be implemented by one or more processors (e.g., 210) coupled with memory (e.g., 215, 220 or 225) storing instructions or data to configure the one or more processors to implement actions or acts 705-730 of the method. At 705, the method can include configuring the survey. At 710, the method can include storing the survey to a local database of a terminal system. At 715, the method can include running the survey rules and sending feedback questions to the terminal system. At 720, the method can include providing survey prompts and receiving user feedback. At 725, the method can include uploading the survey results to a server. At 730, the method can include analyzing the results.

At 705, the method can include configuring the survey. The method can include the entity 702 configuring the survey using the interface of the terminal system. The entity 702 can include any organization, business, or individual that utilizes or provides terminal systems for users or customers to perform electronic operations and collects user feedback. For example, the method can include setting up questions or prompts and determining the schedule of the survey. For instance, the entity operator can utilize the server to create a configuration, including determining or specifying the number of questions per session or assigning different questions to be presented on different days of the week. For example, the entity can configure a survey to include any number of questions or prompts for user interaction, such as 2, 3, 5 or 10 questions to be asked after the electronic operation. This configuration can ensure that the survey is tailored to gather relevant feedback from users based on the entity's requirements.

At 710, the method can include storing the survey to a local database of a terminal system. The method can include pushing the configured survey to the local database of a terminal device or a system. For instance, the survey can include a configuration having 50 pairs of questions and answer choices to provide as a survey or separate questions per day or week. Once the survey (e.g., the prompt or questions and their corresponding answer choices for user selection) is configured, the survey can be stored in the database for future retrieval and analysis. For example, the survey questions can be uploaded to the database, where they are securely stored and can be accessed by the terminal system when needed.

At 715, the method can include running the survey rules and sending feedback questions to the terminal system. The method can include checking if any survey rules are set in the database against the respective transaction details. The system can check the database for any predefined survey rules that should be applied to the transaction details, ensuring that relevant survey questions are generated based on the predefined rules from the local database. For example, if a rule specifies that a particular question should be asked for transactions above a certain amount, the system will generate the appropriate question for such transactions. This can ensure that the survey questions are relevant to the specific transaction being processed.

At 720, the method can include providing survey prompts and receiving user feedback. The method can include capturing the survey response from the user via a display of the terminal system. The terminal system can prompt the user to take the survey, and the user can answer the survey questions presented on the terminal system display. For example, the terminal system can display a series of questions, and the user can provide their responses using the device's keypad or touchscreen.

At 725, the method can include uploading the survey results to a server. The method can include uploading the survey results back to performance component of the terminal system. For instance, after the user completes the survey, the terminal system 102 uploads the survey results to the STPL of the performance component. For example, the survey responses can be securely transmitted to the STPL, where they can be stored in the survey database.

At 730, the method can include analyzing the results. The method can include the entity accessing and reviewing the survey results. The entity can log into the interface platform to analyze the customer feedback and make informed business decisions. For example, the entity can review the survey results to identify areas for improvement in their services or products. This step ensures that the collected feedback is utilized effectively to enhance the overall customer experience.

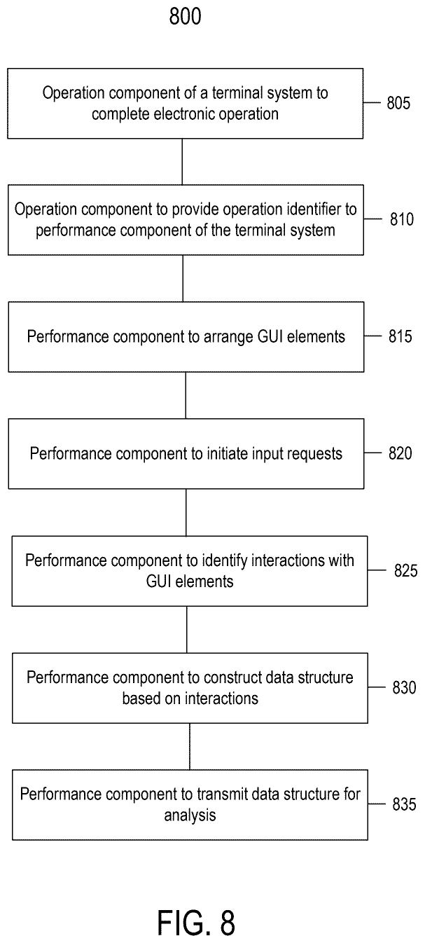

FIG. 8 illustrates an example method 800 for providing secure and interactive user interface for feedback on a terminal system. The method 800 can be implemented using, for example, any combination of example systems 100 and 200 discussed in FIGS. 1-2 along with any other functionalities discussed in connection with FIGS. 3-7. The method 800 can incorporate any acts or operations of method 700 of FIG. 7 and vice versa. The method 800 can be implemented using, for example, one or more processors (e.g., 210) coupled with one or more memories (e.g., 215, 220 or 225) and configured (e.g., via instructions or data stored in the one or more memories) to implement any of the acts, such as acts 805-835. At act 805, the method can include an operation component of a terminal system completing an electronic operation. At act 810, the method can include the operation component providing an operation identifier to a performance component of the terminal system. At act 815, the method can include the performance component arranging GUI elements in a GUI. At act 820, the method can include the performance component initiating input requests. At act 825, the method can include the performance component identifying interactions with GUI elements. At act 830, the method can include the performance component constructing data structure based on interactions. At act 835, the method can include the performance component transmitting the data structure for analysis.

At act 805, the method can include an operation component of a terminal system completing an electronic operation. The method can include a first one or more processors coupled with a first memory of an operation component of a terminal system completing an electronic operation using information. The terminal system can be a single device system and include a terminal device comprising, within the terminal device, an operations component and a performance component. The terminal system can be a distributed system and include an operations component on a first device of the system and a performance component on a second device of the system. The electronic operation can include a purchase transaction, such as a transaction using electronic payment, including a credit card, debit card or a cryptocurrency transaction. The information can include operations data, which can include various confidential or secure information. The information can include, for example, banking account data, credit card information, cryptocurrency account information, username and password information, or any other confidential or secure information of the user.

The method can include the first one or more processors completing the electronic operation using the information corresponding to an electronic account for electronic transactions. The first one or more processors of the operations component can clear from the first memory the information (e.g., confidential or secure information of the user), in response to the completion of the electronic operation. The method can include the first one or more processors determining that the electronic operation is complete and in response to the determination that the electronic operation is complete, clear the memory from all data used for completing the electronic information.

At act 810, the method can include the operation component providing an operation identifier to a performance component of the terminal system. The method can include the first one or more processors, responsive to completion of the electronic operation, transmitting an operation identifier to a performance component of the terminal system. The method can include the first one or more processors generating the operation identifier prior to the completion of the electronic operation or following the completion of the electronic operation. The method can include the first one or more processors generating the operation identifier and transmitting or providing the operation identifier to the performance component prior to the completion of the electronic operation. The method can include the first one or more processors generating the operation identifier and transmitting or providing the operation identifier to the performance component responsive to the completion of the electronic operation.

The first one or more processors of the operation component can be configured to generate the operation identifier to identify the electronic operation from a plurality of electronic operations associated with an entity of the terminal system. The operation identifier can uniquely identify the electronic operation for the system of the entity comprising one or more terminal systems or devices. The operation identifier can include the information for the entity system to identify and access the electronic operation including the operations data.

At act 815, the method can include the performance component arranging GUI elements in a GUI for a display. The method can include a second one or more processors coupled with a second memory of the performance component of the terminal system, causing an arrangement of one or more graphical user interface elements in a graphical user interface of the terminal system, responsive to receipt of the operation identifier. The second one or more processors of the performance component can initiate generating of one or more user questions or prompts in response to receiving or identifying an operation identifier. The performance component can generate one or more user interface elements to form or represent one or more prompts or user questions based on the configuration of the survey provided by the entity.

The second one or more processors of the performance component can identify the one or more graphical user (e.g., GUI) elements for one or more requests for input. The GUI elements can include images, emojis, icons or shapes, as well as characters (e.g., text) configured or arranged to provide a request for the user to input a response or provide a feedback. The performance component can identify GUI elements for one or more request for input based on a second information associated with the electronic operation. The second information can include or correspond to at least one of: a time of day of the electronic operation, a date of the electronic operation, a rate of electronic operations, one or more time durations of the one or more interactions or a portion of the operation identifier indicative of a configuration for the one or more graphical user interface elements to include in the arrangement. The second information can be included in a configuration for the survey to select or provide prompts or questions for display on the GUI based on the second information.

The second one or more processors of the performance component can be configured to provide for display, via the graphical user interface, one or more emojis as the one or more graphical user interface elements corresponding with the one or more requests for input. The emojis, images, shapes or characters can be used to provide region or areas on the GUI displayed on a display with which the user can engage or interact (e.g., touchscreen portion of the display corresponding to a user interaction with a prompt). The second one or more processors of the performance component can be configured to identify historical data of an electronic account associated with an entity of the terminal system. The second one or more processors of the performance component can be configured to adjust the one or more graphical user interface elements, based on the historical data.

At act 820, the method can include the performance component initiating input requests. The method can include the second one or more processors, initiating based on the arrangement of the one or more graphical user interface elements, one or more requests for input via the terminal system. The second one or more processors can initiate requests for input using one or more GUI elements arranged on a GUI to be displayed and illicit or prompt for user response (e.g., touching of the portion of display coinciding with a particular GUI element to select a response). The input requests can be initiated using any combination of textual and graphical elements. The input requests can include or provide a plurality of selections or options for the user to choose from to provide the user interaction indicative of the feedback response to the survey question.

The second one or more processors of the performance component can be configured to identify a time duration of the one or more interactions with one or more requests. The second one or more processors can include the time duration in the data structure, prior to the transmission of the data structure. The second one or more processors can be configured to generate the one or more requests according to a configuration of a survey of the entity. The configuration can be provided by the entity from the server and can be used to select, from a plurality of prompts or questions to present to the user, a selection or a set of questions or prompts. The set of question or prompts can be selected based on the second information (e.g., at act 815) or any portion of the configuration.

At act 825, the method can include the performance component identifying interactions with GUI elements. The method can include the second one or more processors identifying one or more interactions with the one or more graphical user interface elements responsive to the one or more requests. The second one or more processors can identify the user interactions based on signals from GUI elements on the GUI. The signals can be generated by the display in response to user interactions with the portions of the display corresponding to the GUI elements.

The second one or more processors can generate, for display via the graphical user interface, one or more predefined responses for the one or more requests for input. The second one or more processors can receive, via the graphical user interface responsive to the one or more requests for input, one or more inputs corresponding to the one or more predefined responses. The second one or more processors can identify, based on the one or more inputs, the one or more interactions.

During the processing of the performance data on the second one or more processors, the second one or more processors can store in the second memory of the performance component at least one of: the one or more predefined responses, the one or more inputs, the one or more requests or the one or more interactions. Upon completion of the data structure or upon the transmission of the data structure, the second one or more processors can clear the second memory. For instance, in response to the transmission of the data structure or storage of the data structure in a database, the second one or more processors can clear the second memory to remove the data used by the second one or more processors during the acts 815-825.

At act 830, the method can include the performance component constructing data structure based on interactions. The method can include the second one or more processors constructing, based on the one or more interactions, a data structure corresponding to the one or more interactions with the graphical user interface and including the operation identifier. The second one or more processors can construct a data structure having any combination of input requests and user interactions with the GUI elements responsive to the input requests.

The second one or more processors can generate a request identifier to identify a request of the one or more requests for input and include the request identifier in the data structure prior to the transmission of the data structure to the server. The second one or more processors can identify one or more elements of the data structure corresponding to information indicative of the electronic operation and encrypt the one or more elements in the data structure, prior to the transmission of the data structure to the server. The second one or more processors of the performance component can include, in the data structure, a log of the one or more interactions with the graphical user interface elements, the log identifying the one or more interactions and one or more time durations of the one or more interactions.

At act 835, the method can include the performance component transmitting the data structure for analysis. The method can include the terminal system transmitting the data structure to a server via a network. The method can include the performance component transmitting the data structure, via the network, to the server. The second one or more processors can encrypt the data structure according to an encryption protocol prior to the transmission of the data structure for storage at the server. The data structure can include any information on UI elements, input requests, UI interactions, performance data or entity data. The server can provide, responsive to a request comprising at least one of an identifier of the electronic operation or an identifier of an entity associated with the terminal system, the data structure. The server can identify the electronic operation based on the operation identifier of the data structure and analyze the contents of the data structure (e.g., user questions or prompts and GUI interactions or user selections) in view of the operations data (e.g., transactions data, good or services purchased or other transaction information) of the electronic operation.

The server receiving the data structure can be an entity server including point of sale (POS) functionalities to collect and analyze the data structures from a plurality of data structures and determine actions to take to improve the operations of the entity. For example, the server can identify trends in customer feedback and suggest adjustments to the user interface to enhance user experience. The server can analyze the time-based data or data on questions that were not answered by the users to adjust the length and complexity of survey questions, to maintain the questions or time of the survey within a particular temporal range in accordance with user preferences. The server can recommend updates to the configurations to include one or more questions or prompts addressing one or more issues not addressed by prior surveys or configurations. The server can identify or propose improvements to the encryption protocols used by the terminal system to enhance data security during transmission and storage. The server can generate reports for the entity, highlighting areas for improvement and providing actionable insights to enhance overall performance and customer satisfaction at the entity site or facility.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “terminal system”, “system” or “component” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the system 100) to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 100 or computing system 200 can include clients and servers. A client and server are generally remote from each other and typically interact through a communication network (e.g., the network 104). The relationship of client and server arises by virtue of computer programs running on the respective computers and having a client-server relationship to each other. In some implementations, a server transmits data (e.g., data packets representing a digital component) to a client device (e.g., for purposes of displaying data to and receiving user input from a user interacting with the client device).

While operations are depicted in the drawings in a particular order, such operations are not required to be performed in the particular order shown or in sequential order, and all illustrated operations are not required to be performed. Actions described herein can be performed in a different order.

The separation of various system components does not require separation in all implementations, and the described program components can be included in a single hardware or software product. For example, the operations component 110 or performance component 130 can be a single component, app, or program, or a logic device having one or more processing circuits, or part of one or more servers or separate devices.

Having now described some illustrative implementations, it is apparent that the foregoing is illustrative and not limiting, having been provided by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A system, comprising:
a terminal system comprising:
an operation component comprising a first one or more processors coupled with a first memory; and
a performance component comprising a second one or more processors coupled with a second memory;
the operation component to:
complete an electronic operation using information;
transmit, responsive to completion of the electronic operation, an operation identifier to the performance component; and
the performance component to:
cause, responsive to receipt of the operation identifier, an arrangement of one or more graphical user interface elements in a graphical user interface of the terminal system to initiate one or more requests for input via the terminal system;
identify, one or more interactions with the one or more graphical user interface elements responsive to the one or more requests;
construct, based on the one or more interactions, a data structure corresponding to the one or more interactions with the graphical user interface and including the operation identifier; and
transmit, to a server via a network, the data structure.

2. The system of claim 1, wherein the first one or more processors of the operation component are configured to:
complete the electronic operation using the information corresponding to an electronic account for electronic transactions; and
clear, from the first memory, the information in response to the completion of the electronic operation.

3. The system of claim 1, wherein the first one or more processors of the operation component are configured to generate the operation identifier to identify the electronic operation from a plurality of electronic operations associated with an entity of the terminal system, and wherein the second one or more processors are configured to generate the one or more requests according to a configuration of a survey of the entity.

4. The system of claim 1, wherein the second one or more processors of the performance component identify the one or more graphical interface user elements for the one or more requests for input based on a second information associated with the electronic operation.

5. The system of claim 1, where in the second information corresponds to at least one of: a time of day of the electronic operation, a date of the electronic operation, a rate of electronic operations, one or more time durations of the one or more interactions or a portion of the operation identifier indicative of a configuration for the one or more graphical user interface elements to include in the arrangement.

6. The system of claim 1, wherein the second one or more processors are configured to:
encrypt the data structure according to an encryption protocol prior to the transmission of the data structure for storage at the server.

7. The system of claim 1, wherein the second one or more processors are configured to:
generate a request identifier to identify a request of the one or more requests for input; and
include the request identifier in the data structure prior to the transmission of the data structure to the server.

8. The system of claim 1, wherein the second one or more processors are configured to:
generate, for display via the graphical user interface, one or more predefined responses for the one or more requests for input;
receive, via the graphical user interface responsive to the one or more requests for input, one or more inputs corresponding to the one or more predefined responses; and
identify, based on the one or more inputs, the one or more interactions.

9. The system of claim 8, wherein at least one of: the one or more predefined responses, the one or more inputs, the one or more requests or the one or more interactions is stored in the second memory of the performance component prior to the transmission of the data structure, and wherein the second one or more processors are configured to clear the second memory responsive to the transmission of the data structure.

10. The system of claim 1, wherein the second one or more processors of the performance component are configured to provide for display, via the graphical user interface, one or more emojis as the one or more graphical user interface elements corresponding with the one or more requests for input.

11. The system of claim 1, wherein the second one or more processors of the performance component are configured to:
identify a time duration of the one or more interactions with one or more requests; and
include the time duration in the data structure, prior to the transmission of the data structure.

12. The system of claim 1, wherein the second one or more processors of the performance component are configured to:
identify one or more elements of the data structure corresponding to information indicative of the electronic operation; and
encrypt the one or more elements in the data structure, prior to the transmission of the data structure to the server.

13. The system of claim 1, wherein the second one or more processors of the performance component are configured to:
identify historical data of an electronic account associated with an entity of the terminal system; and
adjust the one or more graphical user interface elements, based on the historical data.

14. The system of claim 1, wherein the server is configured to provide, responsive to a request comprising at least one of an identifier of the electronic operation or an identifier of an entity associated with the terminal system, the data structure.

15. The system of claim 1, wherein the second one or more processors of the performance component are configured to include, in the data structure, a log of the one or more interactions with the graphical user interface elements, the log identifying the one or more interactions and one or more time durations of the one or more interactions.

16. A method, comprising:
completing, by a first one or more processors coupled with a first memory of an operation component of a terminal system, an electronic operation using information;
transmitting, by the first one or more processors, responsive to completion of the electronic operation, an operation identifier to a performance component;
causing, by a second one or more processors coupled with a second memory of the performance component of the terminal system, responsive to receipt of the operation identifier, an arrangement of one or more graphical user interface elements in a graphical user interface of the terminal system;
initiating, by the second one or more processors based on the arrangement of the one or more graphical user interface elements, one or more requests for input via the terminal system;
identifying, by the second one or more processors, one or more interactions with the one or more graphical user interface elements responsive to the one or more requests;
constructing, by the second one or more processors, based on the one or more interactions, a data structure corresponding to the one or more interactions with the graphical user interface and including the operation identifier; and
transmitting, by the terminal system, the data structure to a server via a network.

17. The method of claim 16, comprising:
completing, by the first one or more processors of the operation component, the electronic operation using the information corresponding to an electronic account for electronic transactions; and
clearing, from the first memory of the operation component, the information in response to the completion of the electronic operation.

18. The method of claim 16, comprising:
identifying, by the first one or more processors of the operation component, the electronic operation from a plurality of electronic operations associated with an entity of the terminal system; and
generating, by the second one or more processors, the one or more requests according to a configuration of a survey of the entity.

19. The method of claim 16, comprising:
identifying, by the second one or more processors, the one or more graphical interface user elements for the one or more requests for input based on a second information associated with the electronic operation, wherein the second information corresponds to at least one of: a time of day of the electronic operation, a date of the electronic operation, a rate of electronic operations, one or more time durations of the one or more interactions or a portion of the operation identifier indicative of a configuration for the one or more graphical user interface elements to include in the arrangement.

20. A first non-transitory computer-readable medium storing processor-executable instructions which, when executed by a first one or more processors of an operation component of a terminal system, cause the first one or more processors to:
complete an electronic operation using information;
transmit, responsive to completion of the electronic operation, an operation identifier to a performance component; and
a second non-transitory computer-readable medium storing processor-executable instructions, which when executed by a second one or more processors of the performance component of the terminal system, cause the second one or more processors to:
cause, responsive to receipt of the operation identifier, an arrangement of one or more graphical user interface elements in a graphical user interface of the terminal system to initiate one or more requests for input via the terminal system;
identify, one or more interactions with the one or more graphical user interface elements responsive to the one or more requests;
construct, based on the one or more interactions, a data structure corresponding to the one or more interactions with the graphical user interface and including the operation identifier; and
transmit, to a server via a network, the data structure.
